(19) United States
(12) Patent Application Publication
(10) Pub. No.: US 2013/0344908 A1
(43) Pub. Date: Dec. 26, 2013

(54) METHOD AND APPARATUS FOR INTERFERENCE PROCESSING IN WIRELESS COMMUNICATION SYSTEM

(71) Applicant: Samsung Electronics Co., Ltd., Gyeonggi-do (KR)

(72) Inventor: Duck-Dong Hwang, Gyeonggi-do (KR)

(21) Appl. No.: 13/928,128

(22) Filed: Jun. 26, 2013

(30) Foreign Application Priority Data
Jun. 26, 2012 (KR) 10-2012-0068340

(51) Int. Cl. H04W 16/14

(52) U.S. Cl. CPC H04W 16/14
USPC 455/501

(57) ABSTRACT

A method and apparatus process interference in a wireless communication system. A method of a master node for interference processing in a wireless communication system includes determining an interference-alignment dimension that is to perform interference alignment, distributing a dimension remaining after determining the interference-alignment dimension, determining a non-interference-alignment dimension not performing the interference alignment, determining at least one matrix for interference alignment of the plurality of transmitters and the plurality of receivers, and transmitting the determined at least one matrix to at least one of the plurality of transmitters and the plurality of receivers.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Jun. 26, 2012 and assigned Serial No. 10-2012-0068340, the contents of which are herein incorporated by reference.

### TECHNICAL FIELD

The present disclosure relates to a method and apparatus for interference processing in a wireless communication system.

### BACKGROUND

In general, each transmitter and receiver can receive interference signals from neighboring transmitters and neighboring receivers in a communication system in which a plurality of transmitters and a plurality of receivers coexist. Here, the interference signal is one of the causes of reducing a data rate and the reliability of communication.

According to this, recent researches are being actively conducted on reducing interference caused by the neighboring transmitter and the neighboring receiver. For one example, the conventional art is providing technologies for performing interference alignment in a multiple user channel environment in which a plurality of cells are interfering with one another. But, because the conventional interference alignment techniques assume a case where the number of antennas of a transmitter and the number of antennas of a receiver are the same as each other, there is a disadvantage of having a difficulty in applying the conventional interference alignment techniques in a case where the number of antennas of the transmitter and the number of antennas of the receiver are different from each other.

### SUMMARY

To address the above-discussed deficiencies of the prior art, it is a primary object to provide a method and apparatus for interference processing in a wireless communication system.

Another aspect of the present disclosure is to provide a method and apparatus for processing interference in a wireless communication system of an environment in which the number of antennas of a transmitter and the number of antennas of a receiver are different from each other.

A further aspect of the present disclosure is to provide a method and apparatus for aligning interference by some space dimensions to transmit/receive a desired data stream and transmitting/receiving an additional data stream by other some space dimensions to cancel interference in a wireless communication system of an environment in which the number of antennas of a transmitter and the number of antennas of a receiver are different from each other.

Yet another aspect of the present disclosure is to provide a method and apparatus in which one node determines space dimensions for interference alignment and space dimensions for an additional data stream, based on channel information between a plurality of transmitters and a plurality of receivers, in a wireless communication system of an environment in which the number of antennas of a transmitter and the number of antennas of a receiver are different from each other.

Still another aspect of the present disclosure is to provide a method and apparatus in which one node determines a transmission precoder, a reception beamformer, and an interference cancellation matrix, based on channel information between a plurality of transmitters and a plurality of receivers, in a wireless communication system of an environment in which the number of antennas of a transmitter and the number of antennas of a receiver are different from each other.

The above aspects are achieved by providing a method and apparatus for interference processing in a wireless communication system.

According to one aspect of the present disclosure, a method of a master node for interference processing in a wireless communication system is provided. The method includes determining an interference-alignment dimension that is to perform interference alignment, based on the number of antennas of a plurality of transmitters and the number of antennas of a plurality of receivers, distributing a dimension remaining after determining the interference-alignment dimension, to a plurality of transmission/reception links, determining a non-interference-alignment dimension not performing the interference alignment, based on the dimension distributed to the plurality of transmission/reception links, determining at least one matrix for interference alignment of the plurality of transmitters and the plurality of receivers, based on channel information about the plurality of transmitters and the plurality of receivers, the interference-alignment dimension, and the non-interference-alignment dimension, and transmitting the determined at least one matrix to at least one of the plurality of transmitters and the plurality of receivers.

According to another aspect of the present disclosure, a method of a transmitter for interference processing in a wireless communication system is provided. The method includes transmitting a data stream for which interference alignment has been performed by using an interference-alignment dimension previously determined according to the number of antennas of a plurality of transmitters and the number of antennas of a plurality of receivers, and transmitting an additional data stream for which the interference alignment has not been performed by using a non-interference-alignment dimension previously determined according to the number of antennas of the plurality of transmitters and the number of antennas of the plurality of receivers.

According to yet another aspect of the present disclosure, a method of a receiver for interference processing in a wireless communication system is provided. The method includes receiving a data stream for which interference alignment has been performed by using an interference-alignment dimension previously determined according to the number of antennas of a plurality of transmitters and the number of antennas of a plurality of receivers, and receiving an additional data stream for which the interference alignment has not been performed by using a non-interference-alignment dimension previously determined according to the number of antennas of the plurality of transmitters and the number of antennas of the plurality of receivers.

According to still another aspect of the present disclosure, an apparatus of a master node for interference processing in a wireless communication system is provided. The apparatus includes a controller and a transmission unit. The controller determines an interference-alignment dimension that is to perform interference alignment based on the number of antennas of a plurality of transmitters and the number of antennas of a plurality of receivers, distributes a dimension remaining after determining the interference-alignment dimension to a plurality of transmission/reception links, determines a non-interference-alignment dimension not performing the interference alignment based on the dimension distributed to the plurality of transmission/reception links, and determines at least one matrix for interference alignment of the plurality of transmitters and the plurality of receivers based on channel information about the plurality of transmitters and the plurality of receivers, the interference-alignment dimension, and the non-interference-alignment dimension. The transmission unit transmits the determined at least one matrix to at least one of the plurality of transmitters and the plurality of receivers.

According to still another aspect of the present disclosure, an apparatus of a transmitter for interference processing in a wireless communication system is provided. The apparatus includes a precoder. The precoder is comprised of a 1st part of transmitting a data stream for which interference alignment has been performed by using an interference-alignment dimension previously determined according to the number of antennas of a plurality of transmitters and the number of antennas of a plurality of receivers, and a 2nd part of transmitting an additional data stream for which the interference alignment has not been performed by using a non-interference-alignment dimension previously determined according to the number of antennas of the plurality of transmitters and the number of antennas of the plurality of receivers.

According to still another aspect of the present disclosure, an apparatus of a receiver for interference processing in a wireless communication system is provided. The apparatus includes a reception beamforming unit. The reception beamforming unit is comprised of a 1st part of receiving a data stream for which interference alignment has been performed by using an interference-alignment dimension previously determined according to the number of antennas of a plurality of transmitters and the number of antennas of a plurality of receivers, and a 2nd part of receiving an additional data stream for which the interference alignment has not been performed by using a non-interference-alignment dimension previously determined according to the number of antennas of the plurality of transmitters and the number of antennas of the plurality of receivers.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates channels among three links using a multiple antenna;

FIG. 2A illustrates a block diagram of a detailed construction of a precoder in a transmitter according to an exemplary embodiment of the present disclosure;

FIG. 2B illustrates a block diagram of a detailed construction of a reception beamformer in a receiver according to an exemplary embodiment of the present disclosure;

FIG. 3A illustrates a block diagram of a construction of a transmitter according to an exemplary embodiment of the present disclosure;

FIG. 3B illustrates a block diagram of a construction of a receiver according to an exemplary embodiment of the present disclosure; and

FIG. 4 illustrates a flowchart of a procedure of a node of controlling interference alignment according to an exemplary embodiment of the present disclosure.

### DETAILED DESCRIPTION OF THE DISCLOSURE

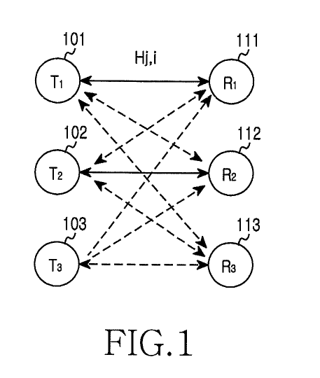

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Preferred embodiments of the present disclosure will be described herein below with reference to the accompanying drawings. In the following description, well-known functions or constructions are not described in detail since they would obscure the disclosure in unnecessary detail. And, terms described below, which are defined considering functions in the present disclosure, can be different depending on user and operator's intention or practice. Therefore, the terms should be defined based on the disclosure throughout this specification.

The present disclosure relates to an interference processing method and apparatus using space alignment in a multiple antenna system.

Below, the present disclosure describes an interference alignment method and apparatus using space alignment in a wireless communication system of an environment in which the number of transmission antennas and the number of reception antennas are different from each other. Below, the present disclosure describes, for example, a wireless communication system in which three transmitters and three receivers coexist for description convenience. Undoubtedly, the present disclosure can be applied in the same way even to a wireless communication system in which a plurality of transmitters and a plurality of receivers coexist.

FIG. 1 illustrates channels among three links using a multiple antenna.

As illustrated in FIG. 1, it is assumed that a transmitter (T1) 101 and a receiver (R1) 111, a transmitter (T2) 102 and a receiver (R2) 112, and a transmitter (T3) 103 and a receiver (R3) 113 concurrently communicate with each other in an environment in which three transmitters (T1) 101, (T2) 102, and (T3) 103 and three receivers (R1) 111, (R2) 112, and (R3) 113 coexist. Here, a link illustrated by a solid line denotes a direct channel for a communication link of each transmitter and receiver pair, and a link illustrated by a dotted line denotes an interference channel for each neighboring transmitter and neighboring receiver. When assuming that the number of antennas of each transmitter is denoted by ‘M’ and assuming that the number of antennas of each receiver is denoted by ‘N’, a channel from a j^{th} transmitter to an i^{th} receiver can be denoted as H_{j,i}. In an exemplary embodiment, the H_{j,i} is an M×M matrix.

If the number (M) of transmitter antennas and the number (N) of receiver antennas are the same as each other, the present disclosure can align interference among three transmitters/receivers by using Equation 1 to Equation 3 below.

That is, when a dimension for a data stream of an i^{th} user of a transmitter is denoted by dᵢ, a precoding matrix for the dᵢ is denoted by Vᵢ. In an exemplary embodiment, the precoding matrix (Vᵢ) is an M×dᵢ matrix. At this time, a data vector (Xᵢ(dᵢ×1)) and the precoding matrix (Vᵢ) are processed by multiplication operation and thus each element of a vector (VᵢXᵢ) is applied to each antenna of the i^{th} transmitter. Also, a j^{th} receiver processes, by multiplication operation, a signal received through a reception antenna and a reception beamformer (Uⱼ(dⱼ×N)), acquiring a signal for restoring a desired dᵢ number of data streams. At this time, the present disclosure can perform communication without interference between the i^{th} transmitter and the j^{th} receiver, by meeting Equation 1 below.

$${U}_{j} {H}_{j} , {}_{i}^{}{V}{}_{i}^{} = [ \begin{matrix}0 & … & 0 \\ ⋮ & ⋱ & ⋮ \\ 0 & … & 0\end{matrix} ] , i \neq j \qquad ( 1 )$$

If Equation 1 above is met, a signal passing through the beamformer (Uⱼ) of the j^{th} receiver has no interference from other users and becomes a state in which only noise is added, as in Equation 2 below.

rᵢ=UᵢH_{i,i}VᵢXᵢ+Nᵢ (2)

To align interference as above, the present disclosure can determine the precoding matrix (Vᵢ) as in Equation 3 below.

V₂=FV₁

V₃=GV₁

E=(H_{3,1})⁻¹H_{3,2}(H_{1,2})⁻¹H_{1,3}(H_{2,3})⁻¹H_{2,1}

F=(H_{3,2})⁻¹H_{3,1}

G=(H_{2,3})⁻¹H_{2,1} (3)

Here, d₁=d₂=d₃=M/2 is given, and an M/2 number of column vectors of the V₁ are arbitrarily determined among an ‘M’ number of Eigen Vectors of a matrix (E). Equation 3 is for an embodiment where the ‘M’ is an even number. If the ‘M’ is an odd number, the present disclosure can use a scheme of performing interference alignment over two symbols through symbol extension, as disclosed in the known “Cadambe & Jafar” paper.

If the number (M) of transmitter antennas and the number (N) of receiver antennas are the same as each other, the present disclosure performs interference alignment among three transmitters/receivers through Equations 1 and 3 above, thereby being capable of performing communication without interference between an i^{th} transmitter and a j^{th} receiver.

But, in an exemplary embodiment of the present disclosure, interference processing using space alignment in a situation in which the ‘M’ and the ‘N’ are different numbers is described below.

If the number (M) of antennas of a transmitter and the number (N) of antennas of a receiver are different from each other, a master node according to the present disclosure determines the number of interference-alignment space dimensions for a data stream to be transmitted applying interference alignment, and determines the number of non-interference-alignment space dimensions for an additional data stream to be transmitted not applying the interference alignment, by considering the number (M) of antennas of a transmitter and the number (N) of antennas of a receiver. Here, the master node can be a specific base station playing a role of a master among a plurality of base stations in a cellular system, or be an upper network controller connected by wired with the plurality of base stations. Also, the master node according to the present disclosure determines a transmission precoder, a reception beamformer, and an interference cancellation matrix, for aligning interference channels by some of interference-alignment space dimensions and aligning direct channels by other some of the interference-alignment space dimensions, and aligning an additional data stream by a non-interference-alignment space dimension to cancel interference, in each receiver, based on all channel information between a plurality of transmitters and a plurality of receivers.

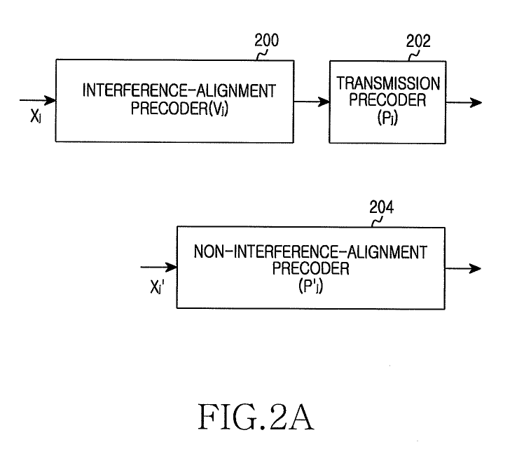

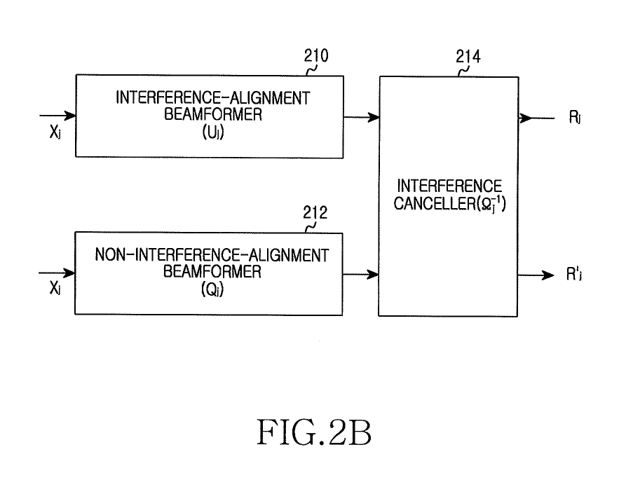

Accordingly, the precoder of the transmitter and the beamformer of the receiver according to the present disclosure each can be composed of a part performing interference alignment and a part not performing the interference alignment, as illustrated in FIGS. 2A and 2B below.

FIG. 2A illustrates a block diagram of a detailed construction of a precoder in a transmitter according to an exemplary embodiment of the present disclosure, and FIG. 2B illustrates a block diagram of a detailed construction of a reception beamformer in a receiver according to an exemplary embodiment of the present disclosure.

As illustrated in FIG. 2A, a precoder of a j^{th} transmitter according to the present disclosure is composed of precoders (Vⱼ) 200 and (Pⱼ) 202 for a data stream applying interference alignment, and a precoder (P′ⱼ)) 204 for an additional data stream not applying the interference alignment. Accordingly, the j^{th} transmitter processes, by multiplication operation, the interference-alignment precoder (Vⱼ) 200 and the transmission precoder (Pⱼ) 202 and symbols (Xⱼ) for transmitting to a j^{th} receiver, and transmits the multiplication operation result to the j^{th} receiver. At this time, the present disclosure performs interference alignment for receivers other than the j^{th} receiver, thus preventing influence on decoding of other receivers. According to this, the j^{th} receiver can receive the symbols (Xⱼ) without interference. Also, the j^{th} transmitter processes, by multiplication operation, the non-interference-alignment precoder (P′ⱼ)) 204 and additional symbols (X′ⱼ) for transmitting to the j^{th} receiver, and transmits the multiplication operation result to the j^{th} receiver in a state where interference is not aligned. Interference can be canceled from this signal in the receiver in collaboration of the transmitter and the receiver.

Also, as illustrated in FIG. 2B, a j^{th} reception beamformer according to the present disclosure can include a beamformer (Uⱼ) 210 for a stream applying interference alignment, a beamformer (Qⱼ) 212 for an additional stream not applying the interference alignment, and a matrix (Ωⱼ⁻¹) 214 for interference cancellation. Accordingly, a j^{th} receiver processes, by multiplication operation, an interference aligned signal (PⱼVⱼXⱼ) received from a j^{th} transmitter and the interference-alignment beamformer (Uⱼ) 210 and processes, by multiplication operation, an interference nonaligned signal (P′ⱼX′ⱼ) received from the j^{th} transmitter and the non-interference-alignment beamformer (Qⱼ) 202. After that, the jth receiver processes, by multiplication operation, the two multiplication operation results and the interference canceller (Ωⱼ⁻¹) 214, acquiring estimation vectors (Rⱼ) and (R′ⱼ).

Thus, the following description is made for a scheme of determining the number of interference-alignment space dimensions and the number of non-interference-alignment space dimensions for an additional data stream and determining a transmission precoder, a reception beamformer, and an interference cancellation matrix, according to the number (M) of transmitter antennas and the number (N) of receiver antennas.

First, a description is made for an embodiment (M>N) where the number (M) of transmitter antennas is greater than the number (N) of receiver antennas.

In an embodiment where the number (M) of transmission antennas is greater than the number (N) of reception antennas, if an (N/2) number of dimensions are determined as dimensions for aligning interference channels, and an (N/2) number of dimensions are determined as dimensions for effective self signals, i.e., direct channels, an (M−N) number of dimensions remain. Accordingly, by using the (M−N) number of remaining dimensions, the present disclosure can transmit/receive an additional data stream in the whole network, i.e., three transmitter/receiver pairs. But, when a transmitter transmits the additional data stream by the (M−N) number of remaining dimensions, a receiver is short of antennas for receiving this additional data stream.

Accordingly, a master node according to the present disclosure determines a J number of dimensions among an N number of antenna dimensions of a receiver, as non-interference-alignment space dimensions for receiving an additional data stream, and determines an (N−J) number of remaining dimensions as interference-alignment space dimensions for interference alignment. At this time, the master node determines the half of the (N−J) number of interference-alignment space dimensions, i.e., an (N−J)/2 number of dimensions as interference channel dimensions for aligning interference channels, and determines the other half, i.e., an (N−J)/2 number of dimensions as direct channel dimensions for effective self signals. That is, because the substantial dimensions performing interference alignment is an (N−J) number, each transmitter has an (M−N+J) number of spare antenna dimensions. By using the (M−N+J) number of spare antenna dimensions, the present disclosure transmits a signal not applying interference alignment. For example, assuming that (M−N+J) is ‘L’, an ‘L’ number of additional streams can be used in an arbitrary transmitter/receiver pair. The ‘L’ number of additional streams can be uniformly used in each of a T1 (101)-R1 (111) link, a T2 (102)-R2 (112) link, and a T3 (103)-R3 (113) link so as to maximize the number of the whole transmission streams. For example, when L=3 is given, three links can use three additional streams, respectively, and, when L=4 is given, the one link can use two additional streams and the remaining two links can use two additional streams, respectively. Accordingly, the master node can distribute an (a, b, c) number of additional streams to each of the T1 (101)-R1 (111) link, the T2 (102)-R2 (112) link, and the T3 (103)-R3 (113) link, and can determine a non-interference-alignment space dimension (J) for additional stream as max (a, b, c).

Accordingly, referring to FIG. 2A, the symbols (X′ⱼ) are composed of column vectors of (a or b or c)×1, and each symbol constituting this column vector is transmitted to a j^{th} receiver without interference alignment. Also, symbols (Xⱼ) are column vectors of (N−J)/2×1, and each symbol constituting this column vector is transmitted to the j^{th} receiver in a state where interference alignment has been performed for receivers other than the j^{th} receiver. According to this, the transmitter illustrated in FIG. 2A transmits a signal illustrated in Equation 4 below.

P′ⱼX′ⱼ+PⱼVⱼXⱼ (4)

After determining the interference-alignment space dimension and the non-interference-alignment space dimension as above, the master node determines a transmission precoder of a transmitter, a reception beamformer of a receiver, and an interference cancellation matrix of the receiver.

First, the master node can determine an interference-alignment beamforming matrix (Uⱼ) as an (N−J)×N matrix having arbitrary values as elements, and gives a rank as (N−J). Next, the master node determines a non-interference-alignment beamforming matrix (Qⱼ) of (a or b or c)×N form that has rows orthogonal to rows of the interference-alignment beamforming matrix (Uⱼ). If ‘M’ and ‘N’ have been known previously, the interference-alignment beamforming matrix (U) and the non-interference-alignment beamforming matrix (Q₁) can have been previously set. Also, the master node determines a transmission precoding matrix (Pⱼ) having, as columns, arbitrary elements orthogonal to rows of channel matrixes having influence on a non-interference-alignment dimension (J) of any other user. The transmission precoding matrix (Pⱼ) is an M×(N−J) matrix, and a rank is (N−J). For example, the master node determines a transmission precoding matrix (P₂) having, as columns, arbitrary elements orthogonal to rows of channel matrixes Q₁H_{1,2} and Q₃H_{3,2} having influence on the non-interference-alignment dimension (J), for the transmitter (T2) 102.

Next, by substituting the H_{i,j} of Equation 3 with an effective channel matrix (UᵢH_{i,j}Pⱼ) between a link (Ri, Tj), the master node determines interference-alignment precoders (V₁, V₂, V₃). In an exemplary embodiment, the effective channel matrix (UᵢH_{i,j}Pⱼ) becomes an (N−J)×(N−J)/2 matrix.

After that, the master node determines a non-interference-alignment precoding matrix) (P′ⱼ) having columns orthogonal to columns of valid interference channels that a corresponding transmitter exerts to any other receiver, for each transmitter. For example, a non-interference-alignment precoding matrix (P′ⱼ) of a transmitter (T1) 101 is determined to have columns orthogonal to columns of valid interference channels (H_{2,1}⁺U₂⁺U₂H_{2,1}P₁V₁, H_{3,1}⁺U₃⁺U₃H_{3,1}P₁V₁, H_{2,1}⁺Q₂⁺Q₂H_{2,2}, and H_{3,1}⁺Q₃⁺Q₃H_{3,3}) that the transmitter (T1) 101 exerts to receivers (R2) 112 and (R3) 113. Assuming that ‘a’, ‘b’, and ‘c’ denote additional data streams transmitted from the transmitters (T1) 101, (T2) 102, and (T3) 103, respectively, the non-interference-alignment precoding matrix (P′ⱼ) becomes an M×(a or b or c) matrix.

After that, the master node determines an interference cancellation matrix (Ωⱼ⁻¹), as represented in Equation 5 below.

$${Ω}_{j}^{- 1} = {[ \begin{matrix}{U}_{j} {H}_{j} , {}_{j}^{}{P}{}_{j}^{} {V}_{j} & {U}_{j} {H}_{j} , {}_{j}^{ }{P}{}_{j}^{′} \\ {Q}_{j} {H}_{j} , {}_{j}^{}{P}{}_{j}^{} {V}_{j} & {Q}_{j} {H}_{j} , {}_{j}^{ }{P}{}_{j}^{′}\end{matrix} ]}^{- 1} \qquad ( 5 )$$

After determining the transmission precoders, the reception beamformers, and the interference cancellation matrix as above, the master node transmits the transmission precoders, the reception beamformers, and the interference cancellation matrix, to each transmitter and receiver.

Next, a description is made for an embodiment (M<N) where the number (M) of transmitter antennas is less than the number (N) of receiver antennas.

In an embodiment where the number (M) of transmission antennas is less than the number (N) of reception antennas, if an (N/2) number of dimensions are determined as dimensions for aligning interference channels, and an (N/2) number of dimensions are determined as dimensions for effective self signals, i.e., direct channels, an (M−N) number of dimensions remain. Accordingly, by using the (M−N) number of remaining dimensions, the present disclosure can transmit/receive an additional data stream in the whole network, i.e., three transmitter/receiver pairs. But, when a receiver receives the additional data stream by the (M−N) number of remaining dimensions, a transmitter is short of antennas for transmitting this additional data stream.

Accordingly, a master node according to the present disclosure determines a J number of dimensions among an M number of antenna dimensions of a transmitter, as non-interference-alignment space dimensions for transmitting an additional data stream, and determines an (M−J) number of remaining dimensions as interference-alignment space dimensions for interference alignment. At this time, the master node determines the half of the (M−J) number of interference-alignment space dimensions, i.e., an (M−J)/2 number of dimensions as interference channel dimensions for aligning interference channels, and determines the other half, i.e., an (M−J)12 number of dimensions as direct channel dimensions for effective self signals. That is, because the substantial dimensions performing interference alignment is an (M−J) number, each transmitter has an (N−M+J) number of spare antenna dimensions. By using the (N−M+J) number of spare antenna dimensions, the present disclosure transmits a signal not applying interference alignment. For example, assuming that (N−M+J) is ‘L’, an ‘L’ number of additional streams can be used in an arbitrary transmitter/receiver pair. The ‘L’ number of additional streams can be uniformly used in each of a T1 (101)-R1 (111) link, a T2 (102)-R2 (112) link, and a T3 (103)-R3 (113) link so as to maximize the number of the whole transmission streams. For example, when L=3 is given, three links can use three additional streams, respectively, and, when L=4 is given, the one link can use two additional streams and the remaining two links can use two additional streams, respectively. Accordingly, the master node can distribute an (a, b, c) number of additional streams to each of the T1 (101)-R1 (111) link, the T2 (102)-R2 (112) link, and the T3 (103)-R3 (113) link, and can determine a non-interference-alignment space dimension (J) for additional stream as max (a, b, c).

Accordingly, referring to FIG. 2A, the symbols (X′ⱼ) are composed of column vectors of (a or b or c)×1, and each symbol constituting this column vector is transmitted to a j^{th} receiver without interference alignment. Also, symbols (X) are column vectors of (M−J)/2×1, and each symbol constituting this column vector is transmitted to the j^{th} receiver in a state where interference alignment has been performed for receivers other than the j^{th} receiver. According to this, the transmitter illustrated in FIG. 2A transmits a signal illustrated in Equation 6 below.

P′ⱼX′ⱼ+PⱼVⱼXⱼ (6)

After determining the interference-alignment space dimension and the non-interference-alignment space dimension as above, the master node determines a transmission precoder of a transmitter, a reception beamformer of a receiver, and an interference cancellation matrix of the receiver.

First, the master node can determine an interference-alignment beamforming matrix (Uⱼ) as an (M−J)×N matrix having arbitrary values as elements, and gives a rank as (N−J). Next, the master node determines a non-interference-alignment beamforming matrix (Qⱼ) of (N−M+J)×N form that has rows orthogonal to rows of the interference-alignment beamforming matrix (Uⱼ). If ‘M’ and ‘N’ have been known previously, the interference-alignment beamforming matrix (Uⱼ) and the non-interference-alignment beamforming matrix (Qⱼ) can have been previously set. Also, the master node determines a transmission precoding matrix (Pⱼ) having, as columns, arbitrary elements orthogonal to rows of channel matrixes having influence on a non-interference-alignment dimension (J) of any other user. The transmission precoding matrix (Pⱼ) is an M×(M−J) matrix, and a rank is (N−J). For example, the master node determines a transmission precoding matrix (P₂) having, as columns, arbitrary elements orthogonal to rows of channel matrixes Q₁H_{1,2} and Q₃H_{3,2} having influence on the non-interference-alignment dimension (J), for the transmitter (T2) 102.

Next, by substituting the H_{i,j} of Equation 3 with an effective channel matrix (UᵢH_{i,j}Pⱼ) between a link (Ri, Tj), the master node determines interference-alignment precoders (V₁, V₂, V₃). In an exemplary embodiment, the effective channel matrix (UᵢH_{i,j}Pⱼ) becomes an (M−J)×(M−J)/2 matrix.

After that, the master node determines a non-interference-alignment precoding matrix (P′ⱼ) having columns orthogonal to columns of valid interference channels that a corresponding transmitter exerts to any other receiver, for each transmitter. For example, a non-interference-alignment precoding matrix (P′ⱼ) of a transmitter (T1) 101 is determined to have columns orthogonal to columns of valid interference channels (H_{2,1}⁺U₂⁺U₂H_{2,1}P₁V₁, H_{3,1}⁺U₃⁺U₃H_{3,1}P₁V₁, H_{2,1}⁺Q₂⁺Q₂H_{2,2} and H_{3,1}⁺Q₃⁺Q₃H_{3,3}) that the transmitter (T1) 101 exerts to receivers (R2) 112 and (R3) 113. Assuming that ‘a’, and ‘c’ denote additional data streams transmitted from the transmitters (T1) 101, (T2) 102, and (T3) 103, respectively, the non-interference-alignment precoding matrix (P′ⱼ) becomes an M×(a or b or c) matrix.

After that, the master node determines an interference cancellation matrix (Ωⱼ⁻¹), as represented in Equation 7 below.

$${Ω}_{j}^{- 1} = {[ \begin{matrix}{U}_{j} {H}_{j} , {}_{j}^{}{P}{}_{j}^{} {V}_{j} & {U}_{j} {H}_{j} , {}_{j}^{ }{P}{}_{}^{′} & 0 & 0 \\ {Q}_{j} {H}_{j} , {}_{j}^{}{P}{}_{j}^{} {V}_{j} & {Q}_{j} {H}_{j} , {}_{j}^{ }{P}{}_{}^{′} & {Q}_{j} {H}_{j} , {}_{i}^{ }{P}{}_{i}^{′} & {Q}_{j} {H}_{j} , {}_{k}^{ }{P}{}_{k}^{′}\end{matrix} ]}^{- 1} \qquad ( 7 )$$

After determining the transmission precoders, the reception beamformers, and the interference cancellation matrix as above, the master node transmits the transmission precoders, the reception beamformers, and the interference cancellation matrix, to each transmitter and receiver.

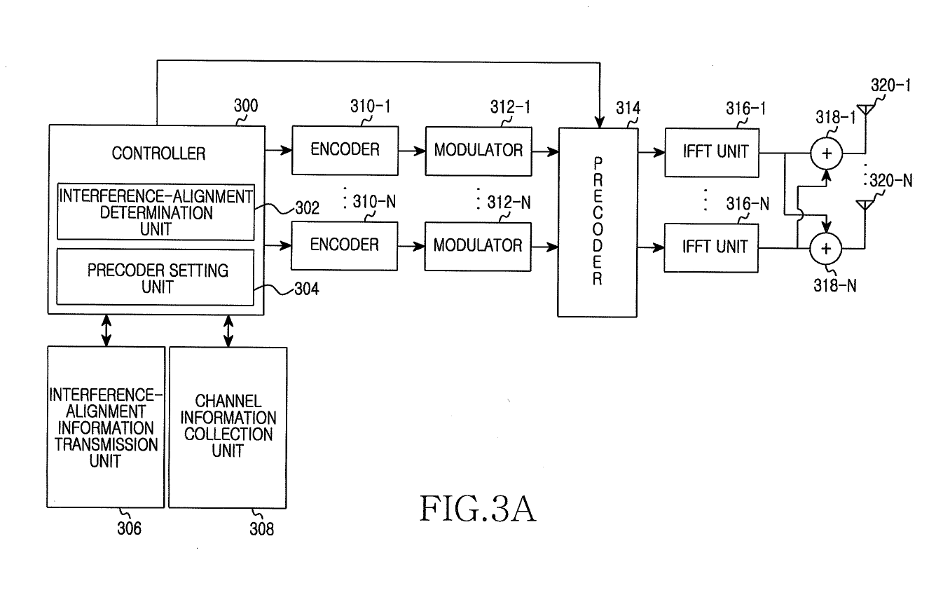

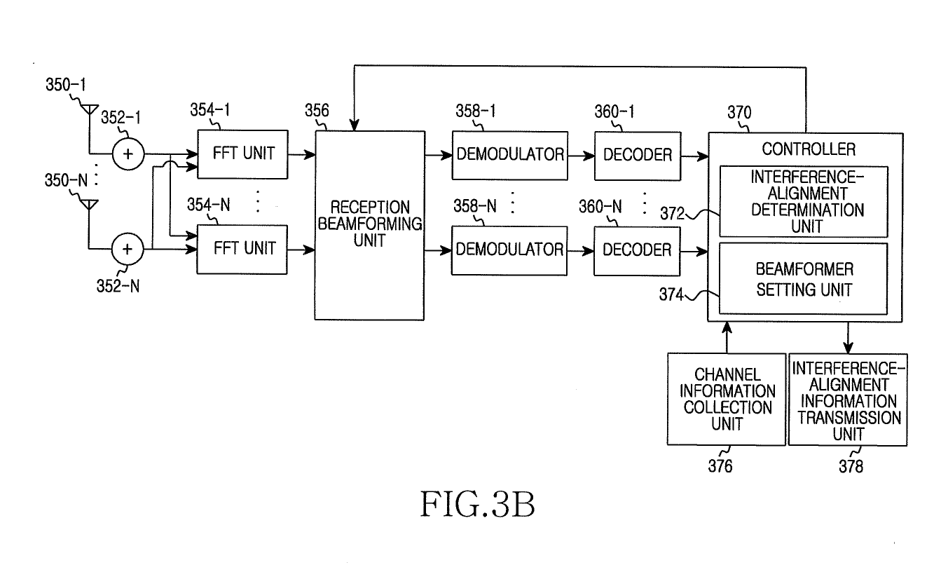

FIG. 3A illustrates a block diagram of a construction of a transmitter according to an exemplary embodiment of the present disclosure.

As illustrated in FIG. 3A, the transmitter includes a controller 300, an interference-alignment information transmission unit 306, a channel information collection unit 308, a plurality of encoders 310-1 to 310-N, a plurality of modulators 312-1 to 312-N, a precoder 314, a plurality of Inverse Fast Fourier Transform (IFFT) units 316-1 to 316-N, a plurality of adders 318-1 to 318-N, and a plurality of antennas 320-1 to 320-N.

The controller 300 controls a function for controlling and processing the general operation of the transmitter. According to the present disclosure, the controller 300 controls and processes a function for transmitting a data stream to be transmitted applying interference alignment by using a predetermined interference-alignment dimension, and transmitting an additional data stream to be transmitted without applying the interference alignment by using a predetermined non-interference-alignment dimension. Particularly, when a corresponding transmitter operates as a master node, the controller 300 acquires all channel information from the channel information collection unit 308 and then, in consideration of the number of antennas of the transmitter and the number of antennas of a receiver, the controller 300 determines an interference-alignment dimension and a non-interference-alignment dimension through an interference-alignment determination unit 302 and determines precoders of the transmitter necessary for this, beamformers of the receiver, and an interference-alignment cancellation matrix of the receiver. After that, the controller 300 controls and processes a function for transmitting information determined in the interference-alignment determination unit 302, to the corresponding transmitter or receiver through the interference-alignment information transmission unit 306.

On the other hand, when the corresponding transmitter does not operate as the master node, the controller 300 controls and processes a function for receiving information necessary for interference alignment from the master node through a precoder setting unit 304, and setting the precoder 314.

The interference-alignment information transmission unit 306 transmits information necessary for interference alignment, i.e., an interference-alignment dimension, a non-interference-alignment dimension, precoders of each transmitter, beamformers of each receiver, and an interference-alignment cancellation matrix of each receiver, to corresponding transmitter and receiver according to the control of the controller 300. In an exemplary embodiment, the interference-alignment information transmission unit 306 can transmit the information necessary for interference alignment to each transmitter and receiver by wired or wireless.

The channel information collection unit 308 acquires channel information between all transmitters/receivers constituting a network according to the control of the controller 300. For example, in an environment in which three transmitter/receiver pairs illustrated in FIG. 1 communicate, the channel information collection unit 308 acquires all of information about effective direct channel and interference channel between three transmitters/receivers. This channel information can be received by wired or wireless after being measured in a plurality of transmitters and receivers.

The plurality of encoders 310-1 to 310-N each encode data to be transmitted through an antenna corresponding to itself. The plurality of modulators 312-1 to 312-N each modulate the encoded data to be transmitted through the antenna corresponding to itself, thereby converting the encoded data into complex symbols.

The precoder 314 processes a signal transmitted through each stream by using precoding matrixes previously set according to the control of the controller 300. As illustrated in FIG. 2A, the precoder 314 is composed of precoders (Vⱼ) 200 and (Pⱼ) 202 for a data stream applying interference alignment, and a precoder (P′ⱼ) 204 for an additional data stream not applying the interference alignment. According to this, a precoder 314 of a j^{th} transmitter receives an input of symbols (Xⱼ) for transmitting to a j^{th} receiver, from modulators corresponding to an interference-alignment dimension among the plurality of modulators 312-1 to 312-N, and processes, by multiplication operation, the input symbols (Xⱼ) and the interference-alignment precoder (Vⱼ) 200 and the transmission precoder (Pⱼ) 202, and outputs the multiplication operation result. Through this, corresponding symbols perform interference alignment for receivers other than the j^{th} receiver, thus preventing influence on decoding of other receivers. Also, the precoder 314 of the the j^{th} transmitter receives an input of additional symbols (X′ⱼ) for transmitting to the j^{th} receiver, from modulators corresponding to a non-interference-alignment dimension among the plurality of modulators 312-1 to 312-N, and processes, by multiplication operation, the input symbols (X′ⱼ) and the non-interference-alignment precoder (P′ⱼ) 204, and transmits the multiplication operation result to the j^{th} receiver in a state where interference is not aligned. Interference can be canceled from this signal in the receiver in collaboration of the transmitter and the receiver.

The plurality of IFFT units 316-1 to 316-N each process, by IFFT operation, signals provided from the precoder 314 and convert a frequency domain signal into a time domain signal. After that, the plurality of adders 318-1 to 318-N process, by addition operation, signals from the plurality of IFFT units 316-1 to 316-N, and output the addition operation results to the plurality of antennas 320-1 to 320-N. The plurality of antennas 320-1 to 320-N transmit corresponding signals to the receiver.

FIG. 3B illustrates a block diagram of a construction of a receiver according to an exemplary embodiment of the present disclosure.

As illustrated in FIG. 3B, the receiver includes a plurality of antennas 350-1 to 350-N, a plurality of adders 352-1 to 352-N, a plurality of Fast Fourier Transform (FFT) units 354-1 to 354-N, a reception beamforming unit 356, a plurality of demodulators 358-1 to 358-N, a precoder 314, a plurality of decoders 360-1 to 360-N, a controller 370, a channel information collection unit 376, and an interference-alignment information transmission unit 378.

The plurality of adders 352-1 to 352-N process, by addition operation, signals received from the plurality of antennas 350-1 to 350-N, and output the addition operation results to the plurality of FFT units 354-1 to 354-N. The plurality of FFT units 354-1 to 354-N each process, by FFT operation, signals provided from the plurality of adders 352-1 to 352-N and convert a time domain signal into a frequency domain signal.

The reception beamforming unit 356 processes a signal received through each stream by using precoding matrixes previously set according to the control of the controller 370. As illustrated in FIG. 2B, the reception beamforming unit 356 is composed of a reception beamformer (Uⱼ) 210 for a data stream applying interference alignment, a beamformer (Qⱼ) 212 for an additional stream not applying the interference alignment, and a matrix (Ωⱼ⁻¹) 214 for interference cancellation. According to this, a reception beamforming unit 356 of a j^{th} receiver processes, by multiplication operation, an interference-aligned signal (PⱼVⱼXⱼ) received from a j^{th} transmitter and the interference-alignment beamformer (Uⱼ) 210, and processes, by multiplication operation, an interference-nonaligned signal (P′ⱼX′ⱼ) received from the j^{th} transmitter and the non-interference-alignment beamformer (Qⱼ) 212. After that, the reception beamforming unit 356 processes, by multiplication operation, the multiplication operation result of the interference-alignment beamformer (Uⱼ) 210 and the multiplication operation result of the non-interference-alignment beamformer (Qⱼ) 212 and the interference canceller (Ωⱼ⁻¹) 214, acquiring estimation vectors (Rⱼ) and (R′ⱼ) for symbols (Xⱼ) and (X′ⱼ).

The plurality of demodulators 358-1 to 358-N each demodulate an estimation vector provided from the reception beamforming unit 356, and the plurality of decoders 360-1 to 360-N each decode demodulated data and outputs the decoded data to the controller 370.

The controller 370 controls a function for controlling and processing the general operation of the receiver. According to the present disclosure, the controller 370 controls and processes a function for receiving a data stream applying interference alignment by using a predetermined interference-alignment dimension, and receiving an additional data stream transmitted without applying the interference alignment by using a predetermined non-interference-alignment dimension. Particularly, when a corresponding receiver operates as a master node, the controller 370 acquires all channel information from the channel information collection unit 376 and then, in consideration of the number of antennas of a transmitter and the number of antennas of the receiver, the controller 370 determines an interference-alignment dimension and a non-interference-alignment dimension through an interference-alignment determination unit 372 and determines precoders of the transmitter necessary for this, beamformers of the receiver, and an interference-alignment cancellation matrix of the receiver. After that, the controller 370 controls and processes a function for transmitting information determined in the interference-alignment determination unit 372, to the corresponding transmitter or receiver through the interference-alignment information transmission unit 378.

On the other hand, when the corresponding receiver does not operate as the master node, the controller 370 controls and processes a function for receiving information necessary for interference alignment from the master node through a beamformer setting unit 374, and setting the reception beamforming unit 356.

The interference-alignment information transmission unit 378 transmits information necessary for interference alignment, i.e., an interference-alignment dimension, a non-interference-alignment dimension, precoders of each transmitter, beamformers of each receiver, and an interference-alignment cancellation matrix of each receiver, to corresponding transmitter and receiver according to the control of the controller 370. In an exemplary embodiment, the interference-alignment information transmission unit 378 can transmit the information necessary for interference alignment to each transmitter and receiver by wired or wireless.

The channel information collection unit 376 acquires channel information between all transmitters/receivers constituting a network according to the control of the controller 370. For example, in an environment in which three transmitter/receiver pairs illustrated in FIG. 1 communicate, the channel information collection unit 376 acquires all of information about effective direct channel and interference channel between three transmitters/receivers. This channel information can be received by wired or wireless after being measured in a plurality of transmitters and receivers.

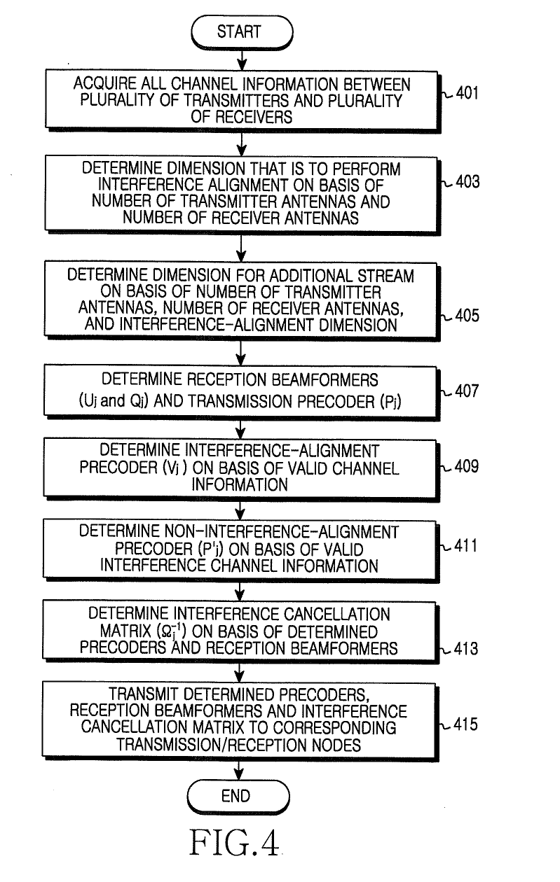

FIG. 4 illustrates a procedure of a node of controlling interference alignment according to an exemplary embodiment of the present disclosure. Here, the master node can be any one node among three transmitters and three receivers illustrated in FIG. 1, or can be an upper network controller. In FIG. 4 below, a description is made assuming that the number (M) of transmission antennas is greater than the number (N) of reception antennas for description convenience, but this description can be identically applied even to an embodiment where the number (M) of transmission antennas is less than the number (N) of reception antennas.

Referring to FIG. 4, in step 401, the master node acquires all channel information between a plurality of transmitters and a plurality of receivers. That is, in an environment in which three transmitter/receiver pairs illustrated in FIG. 1 communicate, the mater node acquires all of information about effective direct channel and interference channel between three transmitters/receivers. This channel information can be forwarded by wired or wireless after being measured in a plurality of transmitters and receivers.

After that, in step 403, the master node determines an interference-alignment dimension that is to perform interference alignment, based on the number of transmitter antennas and the number of receiver antennas. Next, the master node proceeds to step 405 and determines a dimension for an additional stream, i.e., a non-interference-alignment dimension, based on the number of transmitter antennas, the number of receiver antennas, and the interference-alignment dimension. For example, when the number (M) of transmitter antennas is greater than the number (N) of receiver antennas, the master node determines a J number of dimensions among an N number of antenna dimensions of a receiver, as non-interference-alignment space dimensions for receiving an additional data stream, and determines an (N−J) number of remaining dimensions as interference-alignment space dimensions for interference alignment. At this time, the master node determines the half of the (N−J) number of interference-alignment space dimensions, i.e., an (N−J)/2 number of dimensions as interference channel dimensions for aligning interference channels, and determines the other half, i.e., an (N−J)/2 number of dimensions as direct channel dimensions for effective self signals. Here, the master node can uniformly distribute an (M−N+J) number of dimensions by an (a, b, c) number for each of a T1 (101)-R1 (111) link, a T2 (102)-R2 (112) link, and a T3 (103)-R3 (113) link, and can determine max (a, b, c) as a non-interference-alignment space dimension (J).

After that, in step 407, the master node determines interference-alignment reception beamformers (Uⱼ) and (Qⱼ) and a transmission precoder (Pⱼ). For example, the master node can determine an interference-alignment beamforming matrix (Uⱼ) of an (N−J)×N form having arbitrary values as elements, determines a non-interference-alignment beamforming matrix (Qⱼ) of (a or b or c)×N form that has rows orthogonal to rows of the interference-alignment beamforming matrix (Uⱼ), and determines a transmission precoding matrix (Pⱼ) of an M×(N−J) form having, as columns, arbitrary elements orthogonal to rows of channel matrixes having influence on a non-interference-alignment dimension (J) for each transmitter. If ‘M’ and ‘N’ have been known previously, the interference-alignment beamforming matrix (U) and the non-interference-alignment beamforming matrix (Qⱼ) can have been previously set.

Next, in step 409, the master node determines an interference-alignment precoder (Vⱼ) based on valid channel information and, in step 411, the master node determines a non-interference-alignment precoder (P′ⱼ) based on valid interference channel information. For example, by substituting the of Equation 3 with an effective channel matrix (UᵢH_{i,j}Pⱼ) between a link (Ri, Tj), the master node determines interference-alignment precoders (V₁, V₂, V₃) and then, determines a non-interference-alignment precoding matrix (P′ⱼ) of M×(a or b or c) form having columns orthogonal to columns of valid interference channels that a corresponding transmitter exerts to any other receiver.

After that, the master node proceeds to step 413 and determines an interference cancellation matrix (Ωⱼ⁻¹) based on the transmission precoders and the reception beamformers determined in steps 407 to 411. For example, the master node determines an interference cancellation matrix (Ωⱼ⁻¹), as represented in Equation 5 above.

After that, the master node proceeds to step 415 and transmits the precoders of each transmitter, the beamformers of the receiver, and the interference cancellation matrix of the receiver determined in step 407 to step 413, to a corresponding transmission/reception node, and terminates the algorithm according to the present disclosure.

Exemplary embodiments of the present disclosure can obtain an effect of being capable of transmitting/receiving more data streams throughout the system and, due to this, being capable of improving a resource utilization, by performing interference alignment by some space dimensions to transmit/receive a desired data stream, and transmitting/receiving an additional data stream by other some space dimensions to cancel interference in a wireless communication system of an environment in which the number of antennas of a transmitter and the number of antennas of a receiver are different from each other.

While the disclosure has been shown and described with reference to certain preferred embodiments thereof, it will be understood by those skilled in the art that various changes in form and details may be made therein without departing from the spirit and scope of the disclosure as defined by the appended claims.

What is claimed is:

1. A method of operating a master node for interference processing in a wireless communication system, the method comprising:
determining an interference-alignment dimension to use to perform interference alignment based on a number of antennas of a plurality of transmitters and a number of antennas of a plurality of receivers;
distributing a dimension remaining after determining the interference-alignment dimension to a plurality of transmission/reception links;
determining a non-interference-alignment dimension not used to perform the interference alignment based on the dimension distributed to the plurality of transmission/reception links;
determining at least one matrix for interference alignment of the plurality of transmitters and the plurality of receivers based on channel information about the plurality of transmitters and the plurality of receivers, the interference-alignment dimension, and the non-interference-alignment dimension; and
transmitting the determined at least one matrix to at least one of the plurality of transmitters and the plurality of receivers.

2. The method of claim 1, wherein:
the interference-alignment dimension comprises an interference channel dimension for aligning interference channels and a direct channel dimension for an effective self signal, and
the master node is any one node among the plurality of transmitters and the plurality of receivers, or is an upper network control node.

3. The method of claim 1, wherein the at least one matrix comprises at least one of a first precoding matrix for interference alignment of a transmitter, a second precoding matrix for the interference alignment of the transmitter, a precoding matrix for non-interference-alignment of the transmitter, a beamforming matrix for interference alignment of a receiver, a reception beamforming matrix for non-interference-alignment of the receiver, or an interference cancellation matrix of the receiver.

4. The method of claim 3, wherein determining the at least one matrix comprises:
determining the interference-alignment beamforming matrix having arbitrary values as elements;
determining the non-interference-alignment beamforming matrix having rows orthogonal with rows of the interference-alignment beamforming matrix;
determining the second precoding matrix having, as columns, arbitrary elements orthogonal with rows of channel matrixes having influence on the non-interference-alignment dimension;
determining the second precoding matrix based on valid channel information;
determining the precoding matrix for non-interference-alignment based on valid interference channel information; and
determining the interference cancellation matrix based on the determined matrixes.

5. A method of operating a transmitter for interference processing in a wireless communication system, the method comprising:
transmitting a data stream for which interference alignment has been performed using an interference-alignment dimension previously determined according to a number of antennas of a plurality of transmitters and a number of antennas of a plurality of receivers; and
transmitting an additional data stream for which the interference alignment has not been performed using a non-interference-alignment dimension previously determined according to the number of antennas of the plurality of transmitters and the number of antennas of the plurality of receivers.

6. The method of claim 5, further comprising:
acquiring information about at least one matrix; and
setting a precoder of the transmitter using the acquired information about the at least one matrix,
wherein the data stream for which the interference alignment has been performed and the additional data stream for which the interference alignment has not been performed are transmitted using the precoder.

7. The method of claim 6, wherein transmitting the data stream for which the interference alignment has been performed using the predetermined interference-alignment dimension comprises:
using the precoder, multiplying an interference-alignment symbol by a preset interference-alignment first precoding matrix and second precoding matrix to output a multiplication result; and
using the precoder, multiplying a non-interference-alignment symbol by a preset non-interference-alignment precoding matrix to output a multiplication result.

8. A method of operating a receiver for interference processing in a wireless communication system, the method comprising:
receiving a data stream for which interference alignment has been performed using an interference-alignment dimension previously determined according to a number of antennas of a plurality of transmitters and a number of antennas of a plurality of receivers; and
receiving an additional data stream for which the interference alignment has not been performed using a non-interference-alignment dimension previously determined according to the number of antennas of the plurality of transmitters and the number of antennas of the plurality of receivers.

9. The method of claim 8, further comprising:
acquiring information about at least one matrix; and
setting a precoder of the receiver using the acquired information about the at least one matrix,
wherein the data stream for which the interference alignment has been performed and the additional data stream for which the interference alignment has not been performed are received using the precoder.

10. The method of claim 9, further comprising canceling interference of the additional data stream using the beamformer.

11. An apparatus in a master node for interference processing in a wireless communication system, the apparatus comprising:
a controller configured to:
determine an interference-alignment dimension to use to perform interference alignment based on a number of antennas of a plurality of transmitters and a number of antennas of a plurality of receivers,
distribute a dimension remaining after determining the interference-alignment dimension to a plurality of transmission/reception links,
determine a non-interference-alignment dimension not used to perform the interference alignment based on the dimension distributed to the plurality of transmission/reception links, and
determine at least one matrix for interference alignment of the plurality of transmitters and the plurality of receivers based on channel information about the plurality of transmitters and the plurality of receivers, the interference-alignment dimension, and the non-interference-alignment dimension; and
a transmission unit configured to transmit the determined at least one matrix to at least one of the plurality of transmitters and the plurality of receivers.

12. The apparatus of claim 11, wherein:
the interference-alignment dimension comprises an interference channel dimension for aligning interference channels and a direct channel dimension for an effective self signal, and
the master node is any one node among the plurality of transmitters and the plurality of receivers, or is an upper network control node.

13. The apparatus of claim 11, wherein the at least one matrix comprises at least one of a first precoding matrix for interference alignment of a transmitter, a second precoding matrix for the interference alignment of the transmitter, a precoding matrix for non-interference-alignment of the transmitter, a beamforming matrix for interference alignment of a receiver, a reception beamforming matrix for non-interference-alignment of the receiver, or an interference cancellation matrix of the receiver.

14. The apparatus of claim 13, wherein the controller is configured to determine the interference-alignment beamforming matrix having arbitrary values as elements, determine the non-interference-alignment beamforming matrix having rows orthogonal with rows of the interference-alignment beamforming matrix, determine the second precoding matrix having, as columns, arbitrary elements orthogonal with rows of channel matrixes having influence on the non-interference-alignment dimension, determine the second precoding matrix based on valid channel information, determine the precoding matrix for non-interference-alignment based on valid interference channel information, and determine the interference cancellation matrix based on the determined matrixes.

15. An apparatus in a transmitter for interference processing in a wireless communication system, the apparatus comprising:
a precoder unit configured to:
transmit a data stream for which interference alignment has been performed using an interference-alignment dimension previously determined according to a number of antennas of a plurality of transmitters and a number of antennas of a plurality of receivers; and
transmit an additional data stream for which the interference alignment has not been performed using a non-interference-alignment dimension previously determined according to the number of antennas of the plurality of transmitters and the number of antennas of the plurality of receivers.

16. The apparatus of claim 15, further comprising:
a controller configured to acquire information about at least one matrix, and set the precoder unit of the transmitter using the acquired information about the at least one matrix,
wherein the precoder unit is configured to transmit the data stream for which the interference alignment has been performed by the interference-alignment dimension, and transmit the additional data stream for which the interference alignment has not been performed by the non-interference-alignment dimension.

17. The apparatus of claim 16, wherein the precoder unit is configured to multiply an interference-alignment symbol by preset interference-alignment first precoding matrix and second precoding matrix to output a multiplication result, and multiply a non-interference-alignment symbol by a preset non-interference-alignment precoding matrix to output a multiplication result.

18. An apparatus in a receiver for interference processing in a wireless communication system, the apparatus comprising:
a reception beamforming unit configured to:
receive a data stream for which interference alignment has been performed using an interference-alignment dimension previously determined according to a number of antennas of a plurality of transmitters and a number of antennas of a plurality of receivers; and
receive an additional data stream for which the interference alignment has not been performed using a non-interference-alignment dimension previously determined according to the number of antennas of the plurality of transmitters and the number of antennas of the plurality of receivers.

19. The apparatus of claim 18, further comprising:
a controller configured to acquire information about at least one matrix, and set the reception beamforming unit using the acquired information about the at least one matrix,
wherein the reception beamforming unit is configured to receive the data stream for which the interference alignment has been performed by the interference-alignment dimension using an interference-alignment beamforming matrix that is set by control of the controller, and receive the additional data stream for which the interference alignment has not been performed by the non-interference-alignment dimension by using a non-interference-alignment beamforming matrix that is set by control of the controller.

20. The apparatus of claim 19, wherein the reception beamforming unit is configured to cancel interference of the additional data stream using an interference cancellation matrix that is set by control of the controller.
